(19) United States
(12) Patent Application Publication
(10) Pub. No.: US 2025/0361870 A1
(43) Pub. Date: Nov. 27, 2025

(54) MULTI-STAGE COMPRESSOR

(71) Applicant: MAN Energy Solutions SE, Augsburg (DE)

(72) Inventors: Max KRAMER, Zürich (CH); Yves BIDAUT, Winterthur (CH); Jörg DOLD, Hohentengen (DE); Leon SCHRÖDER, Dresden (DE); Michael SCHIFFNER, Dresden (DE); Sebastian SPITZER, Dresden (DE); Maik GUDE, Dresden (DE)

(21) Appl. No.: 19/200,217

(22) Filed: May 6, 2025

(30) Foreign Application Priority Data
May 23, 2024 (DE) 10 2024 114 446.7

(51) Int. Cl. F04D 17/12; F04D 29/02; F04D 29/28

(52) U.S. Cl. CPC F04D 17/12; F04D 29/023; F04D 29/286

(57) ABSTRACT

A multi-stage compressor, namely a multi-stage radial compressor or a multi-stage diagonal compressor, having a compressor rotor, the compressor rotor has a rotor shaft and multiple impellers fastened to the rotor shaft which are subjected to inflow in the axial direction and impellers which are subjected to outflow in the radial direction or diagonal direction. Each impeller has a curved inner shroud, a curved outer shroud and multiple curved impeller blades arranged between the inner shroud and the outer shroud. The inner shroud, the outer shroud, and the impeller blades each consists of a fibre composite material. The rotor shaft extends through a recess in the inner shroud of the respective impeller.

### BACKGROUND OF THE INVENTION

### 1. Field of the Invention

The disclosure relates to a multi-stage compressor.

### 2. Description of Related Art

In thermal fluid-flow machines, a basic distinction is made between compressors and steam and gas turbines. Fluid-flow machines are also referred to as turbomachines. In compressors, a basic distinction is made between axial compressors and radial compressors as well as diagonal compressors. Further, in axial compressors and also radial compressors as well as diagonal compressors a distinction is made between single-stage compressors and multi-stage compressors. The disclosure present here relates to multi-stage compressors, namely either multi-stage radial compressors or multi-stage diagonal compressors.

For compressing light gases such as for example hydrogen gas or helium gas, the compressors have to be operated with high circumferential speeds in order to make possible an efficient compression. Multi-stage radial compressors or multi-stage diagonal compressors known to date are of metallic design and only conditionally suited for being operated with high circumferential speeds, which are required for compressing light gases.

DE 11 2011 100 312 T5 discloses an impeller of a radial compressor which, using a resin transfer moulding (RTM) method, is produced as composite material impeller. The impeller is formed from a fibre composite material, namely from fibres embedded in resin.

EP 2 504 581 B1 discloses an impeller for a turbomachine having multiple blades. The inner walls of the blades are connected to a fabric element, which includes fibre structures woven into a pattern.

### SUMMARY OF THE INVENTION

There is a need for a new type of multi-stage compressor designed as radial compressor or diagonal compressor, which can be operated with high circumferential speeds and is thus suitable for compressing light gases. Starting out from this, an object of one aspect of the present invention is based on creating a new type of multi-stage compressor designed as radial compressor or diagonal compressor.

According to one aspect of the invention, each impeller comprises a curved inner shroud, a curved outer shroud and multiple curved impeller blades arranged between the inner shroud and the outer shroud, wherein the inner shroud, the outer shroud, and the impeller blades each consist of a fibre composite material, and wherein the rotor shaft extends through a recess in the inner shroud of the respective impeller. The inner shroud can also be referred to as hub shroud and the outer shroud can also be referred to as cover shroud. The curved impeller blades can be three-dimensionally twisted.

With one aspect of the invention present here, a multi-stage compressor designed as radial compressor or diagonal compressor is proposed for the first time the impellers of which have a curved inner shroud, a curved outer shroud, and multiple curved, in particular three-dimensionally twisted impeller blades arranged between the curved inner shroud and the curved outer shroud, which overall consist of a fibre composite material. The rotor shaft extends through a recess in the inner shroud of the respective impeller. Such multi-stage compressors can be operated with high circumferential speeds. Accordingly, such compressors are suitable for compressing hydrogen gas or other light gases such as helium gas, natural gas, ammonia, neon, or mixtures of at least two such gases.

The impeller blades, the inner shroud, and the outer shroud can be integral parts of the respective impeller in integral design.

Preferentially, the impeller blades, the inner shroud, and the outer shroud are separate components of the respective impeller formed in differential design, wherein the impeller blades are connected to the inner shroud and the outer shroud at least via an integral and/or positive connection. Optionally, the impeller blades can be additionally connected to the inner shroud and the outer shroud via mechanical connecting elements. For easy manufacturability of the multi-stage compressor according to one aspect of the invention it is advantageous that the impeller blades, the inner shroud, and the outer shroud are each formed as separate components, which are at least connected via an integral connection. Such impellers formed in differential design can be operated with high circumferential speeds and, compared with impellers in integral design, are easy to produce.

Preferentially, each impeller is connected to the rotor shaft at least via a non-positive connection. Optionally, each impeller can be additionally connected to the rotor shaft via an integral and/or positive connection. Thus, a particularly advantageous connection of the respective impeller to the rotor shaft can be provided in order to thereby provide a multi-stage compressor that can be operated with high circumferential speeds.

Preferentially, the fibre composite material of the inner shroud includes highly rigid fibres in the connecting region to the rotor shaft, wherein the fibre composite material of the inner shroud outside the connecting region to the rotor shaft and the fibre composite material of the outer shroud and of the impeller blades includes high-strength fibres. Accordingly, the respective impeller includes different fibres, namely on the one hand highly rigid fibres and on the other hand high-strength fibres. The highly rigid fibres are employed in the region of the inner shroud of the respective impeller, namely in such portions of the inner shroud which serve for the connection to the rotor shaft. In other portions of the inner shroud and in the region of the outer shroud and of the impeller blades, the fibre composite material includes preferentially high-strength fibres. Finally, the impellers can be securely fastened to the rotor shaft of the multi-stage compressor in order to ensure high circumferential speeds. In addition to this, any combinations of the mentioned fibre types are possible in the abovementioned regions and in particular in transitions between the mentioned regions.

Preferentially, the inner shroud, in the connecting region of the same to the rotor shaft, comprises fibres extending in the axial direction and fibres extending in the tangential direction and outside the connecting region to the rotor shaft, fibres extending in the radial direction and fibres extending in the tangential direction. Alternatively or additionally, the inner shroud comprises fibres extending in at least one main stress direction of the inner shroud, in particular fibres extending in a tensile stress direction and/or fibres extending in a compressive stress direction. By way of such an orientation of the fibres, the impellers can withstand high loads so that the respective multi-stage compressor can be ultimately operated with high circumferential speeds.

Preferred further developments of the invention are obtained from the subclaims and the following description.

### BRIEF DESCRIPTION OF THE DRAWINGS

Exemplary aspects of the invention are explained in more detail by way of the drawing without being restricted to this. There it shows:

FIG. 1: is a sectional view by way of an extract of a multi-stage compressor in a region of an impeller;

FIG. 2: is a perspective representation of an impeller of a multi-stage compressor;

FIG. 3: is an exploded representation of the impeller of FIG. 2;

FIG. 4: is an impeller blade of the impeller of FIG. 2;

FIG. 5: is a detail, namely a fibre orientation, of an inner shroud of the impeller of FIG. 2;

FIG. 6: is a further detail, namely a fibre orientation and the course of main stress directions, of an inner shroud of the impeller of FIG. 2;

FIG. 7: is a further detail, namely a sectional view, of an inner shroud of the impeller of FIG. 2 with fibre layers; and

FIG. 8: is a detail, namely a profile of an impeller blade of the impeller of FIG. 2.

### DETAILED DESCRIPTION OF THE PRESENTLY PREFERRED EMBODIMENTS

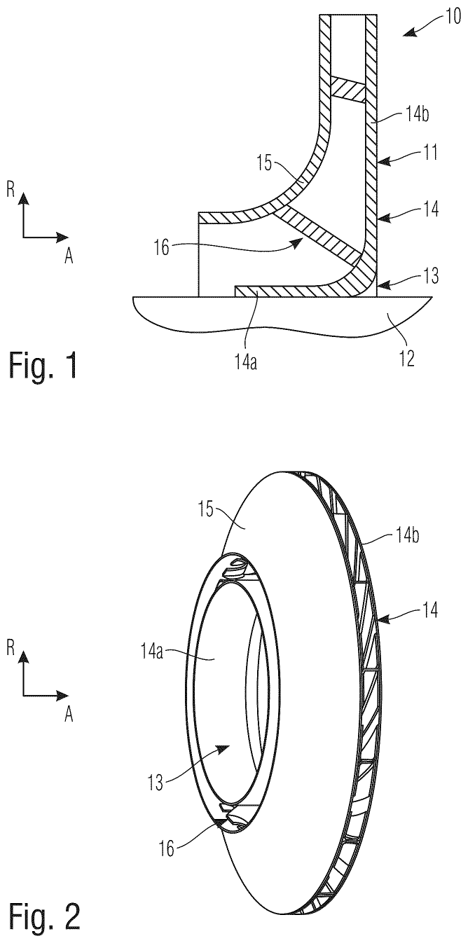

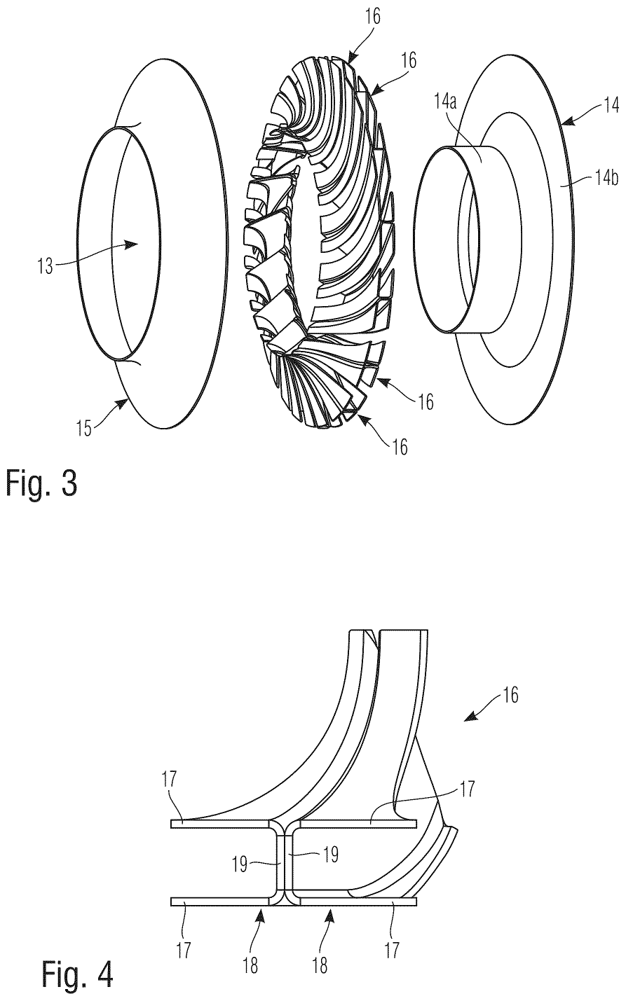

FIG. 1 shows a sectional view by way of an extract of a multi-stage compressor 10 according to one aspect of the invention in a region of an impeller 11 of the compressor 10, which is arranged on a rotor shaft 12. Seen in the axial direction A, multiple such impellers 11 are arranged one behind the other on the outer circumference of the rotor shaft 12.

Together with the impellers 11, the rotor shaft 12 forms a compressor rotor, which is rotatably mounted in a compressor housing of the multi-stage compressor 10 which is not shown.

The compressor 10, according to one aspect of the invention, is a multi-stage radial compressor, or a multi-stage diagonal compressor. Accordingly, the impellers 11 are subjected to an inflow of gas to be compressed in the axial direction A, while the outflow direction extends in the radial direction R, or diagonally thereto.

The respective impeller 11 of the multi-stage compressor 10 comprises a curved or arched inner shroud 14, a curved or arched outer shroud 15, and multiple curved or arched impeller blades 16 arranged between the inner shroud 14 and the outer shroud 15.

The inner shroud 14, the outer shroud 15, and the impeller blades 16 of the respective impeller 11 each consists of a fibre composite material, wherein the rotor shaft 12 extends through a recess 13 in the inner shroud 14 of the respective impeller 11.

The inner shroud 14 can also be referred to as hub shroud and the outer shroud 15 can also be referred to as cover shroud. The curved or arched impeller blades 16 are three-dimensionally twisted.

As already explained above, the respective impeller 11 and thus its impeller blades 16 are subjected to an inflow in the axial direction A and to an outflow in the radial direction R or diagonal direction.

The impeller blades 16, the inner shroud 14 and the outer shroud 15, which each consist of a fibre composite material, can be integral parts of a respective impeller 11 formed in integral design.

In order to make possible a simple manufacture of the respective impeller 11, it is preferred, however, when the inner shroud 14, the outer shroud 15, and the impeller blades 16 are each embodied as separate components of an impeller 11 formed in differential design, wherein then the impeller blades 16 on the one hand are connected to the inner shroud 14 and on the other hand to the outer shroud 15 at least via an integral connection.

Accordingly, the impeller blades 16, with an impeller 11 in differential design, are integrally connected to the inner shroud 14 and the outer shroud 15 at least via an adhesive connection, if required, the impeller blades 16 are additionally connected to the inner shroud 14 and the outer shroud 15 via mechanical connecting elements, such as for example bolts, rivets, or screws.

Integrally connecting the impeller blades 16 to the inner shroud 14 and the outer shroud 15 in the case of thermoplastics can also take place by welding.

FIG. 4 shows an impeller blade 16 on its own, which is designed as double-T-shaped impeller blade 16 in cross section. Free legs 17 of the impeller blade 16 are connected to the inner shroud 14 and the outer shroud 15, at least by gluing and additionally by mechanical connecting elements, as explained above.

Glueing the respective impeller blades 16 in the region of their free legs 17 to the inner shroud 14 and the outer shroud 15 preferentially takes place over the full surface area in the region of the respective free legs 17.

In addition, mechanical connecting elements can extend through the free legs 17 and through the inner shroud 14 and the outer shroud 15 for additional connection, which in particular counteract a so-called peeling of the shrouds 14, 15 under operating loads and increase the load capacity of the impeller 11.

The impeller blades 16 can be embodied in integral design or differential design. In the exemplary embodiment shown in FIG. 4, the impeller blade 16 of double-T design in the cross-section is embodied in differential design and formed of two U-shaped profiles 18, which are arranged back to back and the free legs 17 of which extend away from the central parts 19 connecting the free legs 17, which form backs of the U-shaped profiles 18. The central parts 19 of the U-shaped profiles 18 in turn are at least integrally connected by glueing and optionally also additionally via mechanical connecting elements such as bolts, rivets, or screws.

Although the provision of, in the cross-section double-T-shaped impeller blades 16, via U-shaped profiles 18 positioned back to back is preferred, it is also possible to provide a double-T-shaped impeller blade 16, which comprises a single central part 19, from which the free legs 17 then extend away as shown in FIG. 4. FIG. 8 shows an extract from a, in the cross-section double-T-shaped impeller blade 16 with a single central part 19, wherein in transition regions between the central part 19 and the free legs 17 inserts or cores 20 of plastic, fibre composite material, foam rubber or the like can be arranged.

As already explained, the rotor shaft 12 extends through a recess 13 in the respective impeller 11 of the multi-stage compressor 10. The respective impeller 11 sits on the rotor shaft 12 with its impeller seat, which is formed by the inner shroud 14.

The rotor shaft 12 is preferentially formed from a metallic material, but the same can also consist of a fibre composite material. In particular, when the rotor shaft 12 consists of a metallic material, for example of a steel material, the impellers 11 are connected to the rotor shaft 12 at least via a frictional connection, for example a press-fit connection.

For forming such a press-fit connection, the rotor shaft 12 of a metallic material can be cooled and in the cooled state introduced into the recesses 13 of the impellers 11, so that following the heating of the rotor shaft 12 the press-fit connection between the rotor shaft 12 and the impellers 11 is formed.

In addition to the frictional connection, each impeller 11 can be additionally connected to the rotor shaft 12 via an integral connection such as an adhesive connection and/or a positive connection such as for example a profile connection or a dowel pin connection.

As already explained, the inner shroud 14, the outer shroud 15 and the impeller blades 16 are produced from a fibre composite material. The fibre composite material of the inner shroud 14 preferentially comprises highly rigid HT fibres in the connecting region to the rotor shaft 12, i.e. in a portion 14a extending in the axial direction A, which defines the recess 13 of the respective impeller 11 for the passage of the rotor shaft 12. In other portions 14b extending in the radial direction R, the fibre composite material of the inner shroud 14 preferentially comprises high-strength HT fibres. The fibre composite material of the outer shroud 15 and of the impeller blades 16 also includes preferentially high-strength HT fibres. In the abovementioned regions or portions, combinations of different fibre types can also be employed.

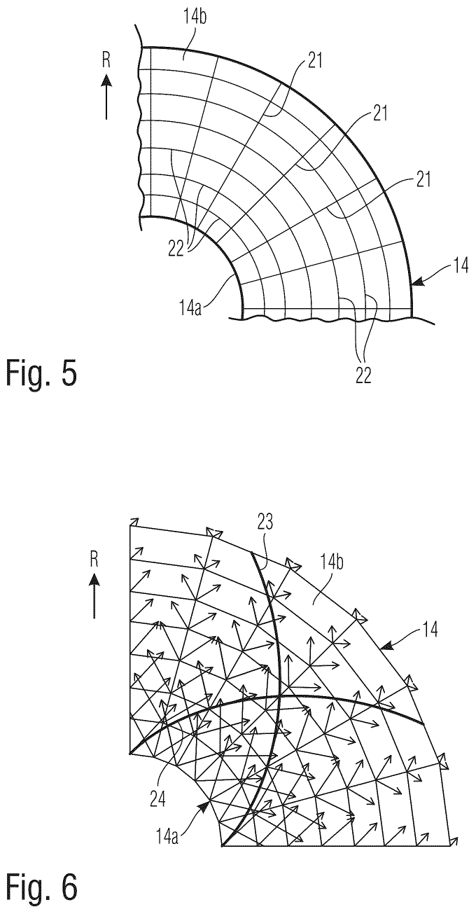

FIGS. 5 and 6 show possible courses of the fibres in the region of the inner shroud 14, namely in the region of that portion 14b of the inner shroud 14, which extends outside the connecting region 14a to the rotor shaft 12 in the radial direction R. According to FIG. 5, fibres 21 outside the connecting region 14a of the inner shroud 14 extend in the radial direction R, further fibres 22 extend in the tangential direction or circumferential direction. In the region of the portion 14a, i.e. in the connecting region of the inner shroud 14 to the rotor shaft 12, fibres 21 extend in the axial direction and fibres 22 in the tangential direction or circumferential direction. This is not shown in FIGS. 5 and 6.

According to FIG. 6, fibres outside the connecting region 14a of the inner shroud 14 extend in at least one main stress direction of the portions 14b of the inner shroud 14 extending in the radial direction R, namely at least one fibre 23 in the tension direction and at least one fibre 24 in the compression direction of the inner shroud 14 outside the connecting region 14a of the same to the rotor shaft 12.

Although in FIG. 6 merely a fibre 23 extending in the tension direction and a fibre 24 extending in the compression direction are shown, obviously multiple such fibres 23, 24 extending in the main stress directions can be present viewed over the circumference.

The fibre routing of FIG. 5 can be combined with the fibre routing of FIG. 6 namely in multiple layers of fibres arranged on top of one another.

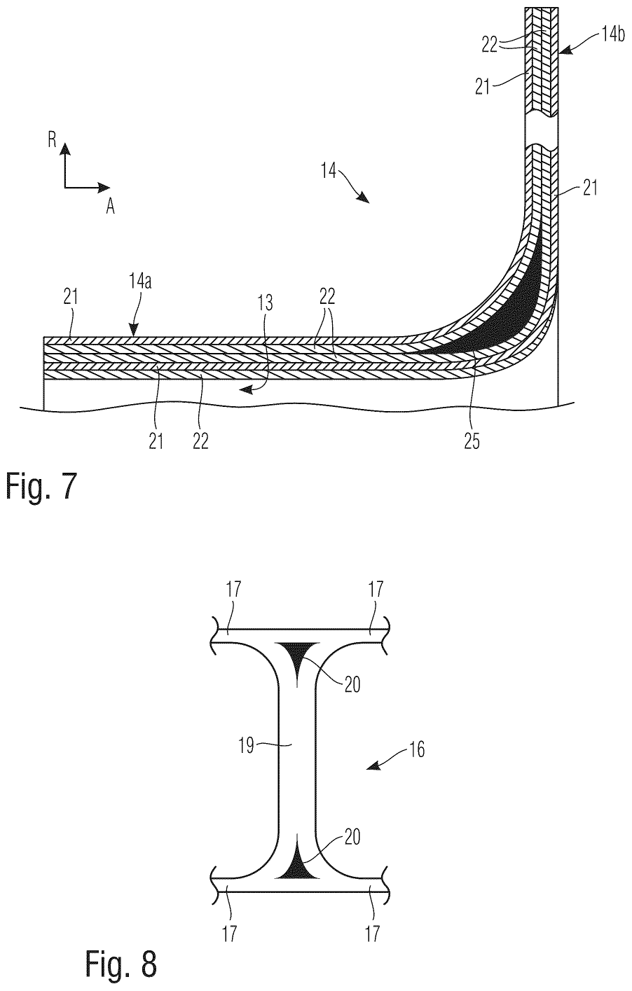

FIG. 7 shows a cross-section through an inner shroud 14 in the axial cutting direction, wherein from FIG. 7 it is evident that the inner shroud 14 in the portions 14a, 14b comprises multiple layers of fibres 21, 22.

Accordingly, in the exemplary embodiment of FIG. 7 an innermost layer of fibres 22 extending in the tangential or circumferential directions is formed in the region of the connecting portion 14a of the inner shroud 14 to the rotor shaft 12. Thereon, a layer of fibres 21 extending in the axial direction A is placed, wherein these fibres 21 in the portion 14b extend in the radial direction R and in the shown exemplary embodiment form the innermost fibre layer of the portion 14b. On this layer of fibres 21 extending in the region of the portion 14a in the axial direction and in the region of the portion 14b in the radial direction, two layers of fibres 22 extending in the tangential or circumferential direction R positioned, wherein in the transition region between the portion 14a and the portion 14b between these two layers of the fibres 22, a core 25 of for example plastic, fibre composite material, foam rubber or the like is positioned. The outermost layer of fibres 21 in the region of the portion 14a of the inner shroud 14 and in the region of the portion 14b of the inner shroud 14 is formed by fibres 21, which in the portion 14a extend in the axial direction A of the inner shroud 14 and thus of the impeller 11 and in the portion 14b in the radial direction R of the inner shroud 14 and thus of the impeller 11.

The outer shroud 15 can also consist of a fibre composite material and comprise fibres extending in the axial direction and/or radial direction and/or tangential direction or circumferential direction.

With the multi-stage compressor 10, according to the invention, high circumferential speeds can be ensured. Thus, the multi-stage compressor 10 is particularly suited for compressing light gases, such as hydrogen gas, helium gas, natural gas, ammonia, neon, or mixtures of such gases. Thus, the multi-stage compressor 10 according to the invention, is preferentially utilised for compressing and/or transporting such gases or gas mixtures.

As matrix material of the respective fibre composite material, resins such as for example epoxy resins or thermoplastics such as, for example PEEK can be utilised. The fibres are preferentially carbon fibres.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A multi-stage compressor, configured as a multi-stage radial compressor or multi-stage diagonal compressor, comprising:
a compressor rotor, wherein the compressor rotor comprises:
a rotor shaft; and
multiple impellers fastened to the rotor shaft, which are subjected to inflow in an axial direction and outflow in a radial direction or a diagonal direction,
wherein each impeller comprises:
an inner shroud that is curved;
an outer shroud that is curved; and
multiple impeller blades that are curved and arranged between the inner shroud and the outer shroud,
wherein the inner shroud, the outer shroud, and the impeller blades each consists of a fibre composite material, and
wherein the rotor shaft extends through a recess in the inner shroud of a respective impeller.

2. The multi-stage compressor according to claim 1, wherein the impeller blades, the inner shroud and the outer shroud are integral parts of the respective impeller formed in integral design.

3. The multi-stage compressor according to claim 1, wherein the impeller blades, the inner shroud, and the outer shroud are separate components of the respective impeller formed in differential design, which are connected at least via an integral connection.

4. The multi-stage compressor according to claim 3, wherein the impeller blades are connected to the inner shroud and the outer shroud at least via an adhesive connection.

5. The multi-stage compressor according to claim 4, wherein the impeller blades are additionally connected to the inner shroud and the outer shroud via mechanical connecting elements.

6. The multi-stage compressor according to claim 1, wherein the rotor shaft, which consists of a metallic material or a fibre composite material, and each impeller are at least connected via a frictional connection.

7. The multi-stage compressor according to claim 6, wherein the rotor shaft and each impeller are connected via a press-fit connection.

8. The multi-stage compressor according to claim 7, wherein the rotor shaft and each impeller are additionally connected via an integral connection and/or positive connection.

9. The multi-stage compressor according to claim 1, wherein:
the fibre composite material of the inner shroud, in a connecting region to the rotor shaft, includes highly rigid fibres, and
the fibre composite material of the inner shroud, outside the connecting region to the rotor shaft and the fibre composite material of the outer shroud and of the impeller blades includes high-strength fibres.

10. The multi-stage compressor according to claim 9, wherein:
the fibre composite material of the inner shroud in the connecting region to the rotor shaft additionally includes high-strength fibres, and/or
the fibre composite material of the inner shroud, outside the connecting region to the rotor shaft, and the fibre composite material of the outer shroud and of the impeller blades additionally includes highly rigid fibres.

11. The multi-stage compressor, according to claim 9, wherein:
the inner shroud, in the connecting region of the inner shroud towards the rotor shaft, comprises fibres extending in the axial direction and fibres extending in a tangential direction, and
the inner shroud, outside the connecting region to the rotor shaft, comprises fibres extending in the radial direction and fibres extending in the tangential direction.

12. The multi-stage compressor according to claim 1, wherein
the inner shroud comprises fibres extending in at least one main stress direction of the inner shroud.

13. The multi-stage compressor according to claim 1,
wherein each impeller blade is formed double-T-shaped in cross-section, and
wherein free legs of the double-T-shaped impeller blades extend along the inner shroud and the outer shroud.

14. The multi-stage compressor according to claim 13, wherein each impeller blade, in transition regions from the free legs comprises a core in at least one central part connecting the legs.

15. The multi-stage compressor according to claim 1 configured to compress and/or transport hydrogen gas, helium gas, natural gas, ammonia, neon, or a mixture of at least two of these gases.

16. The multi-stage compressor according to claim 5, wherein the mechanical connecting elements are bolts, rivets, or screws.

17. The multi-stage compressor according to claim 12, wherein
the inner shroud comprises fibres extending in a tensile stress direction and/or fibres extending in a compressive stress direction.
